(19) United States
(12) Patent Application Publication
(10) Pub. No.: US 2025/0280430 A1
(43) Pub. Date: Sep. 4, 2025

(54) Resource Allocation for Wireless Communication and Sensing

(71) Applicant: Apple Inc., Cupertino, CA (US)

(72) Inventors: Firouz Behnamfar, Los Gatos, CA (US); Christian W. Mucke, Portimão (PT); Oghenekome Oteri, San Diego, CA (US); Ayman F. Naguib, Cupertino, CA (US)

(21) Appl. No.: 18/863,602

(22) PCT Filed: May 10, 2023
(86) PCT No.: PCT/US2023/021656

§ 371 Date: Nov. 6, 2024

Related U.S. Application Data
(60) Provisional application No. 63/364,699, filed on May 13, 2022.

(51) Int. Cl. H04W 72/51; H04L 5/00; H04W 74/0833

(52) U.S. Cl. CPC H04W 72/51; H04L 5/0035; H04L 5/0094; H04W 74/0841

(57) ABSTRACT

A terminal communicating with other terminals may be configured to perform one or more Joint Communication and Sensing (JCAS) transmissions. These transmissions may be used by the terminal to exchange communication data and perform sampling for a sensor at a same time. The one or more JCAS transmissions may be transmissions following protocols in which the terminal follows a resource allocation pattern to allocate communication resources and sensing resources simultaneously. The terminal may use the JCAS transmission to allocate communication resources and sensing resources in one or multiple transmission frequency bands (e.g., bandwidth portions or parts, frequency ranges, subcarriers). The terminal may implement the JCAS transmissions in coordination with base stations and/or other terminals to prevent collisions of any transmitted data. The terminal may use the resource allocation patterns to coordinate these JCAS transmissions with devices connected through multiple radio access technologies (RATs).

### FIELD

The present application relates to wireless devices and wireless networks, including devices, circuits, and methods for performing resource allocation schemes for joint wireless communication and sensing.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

In one or more embodiments, a first terminal includes a processor configured to determine a resource allocation pattern to be used in a joint transmission to a second terminal. The resource allocation pattern is determined based on a terminal capability of the first terminal. The first terminal includes a transmitter that transmits, to the second terminal, a first signal indicating the resource allocation pattern to be used in the joint transmission. The resource allocation pattern includes a first set of resources allocated for communication and a second set of resources allocated for sensing.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates a base station (BS) in communication with a user equipment (UE) device, according to some aspects.

FIG. 3 illustrates an example block diagram of a UE, according to some aspects.

FIG. 4 illustrates an example block diagram of a BS, according to some aspects.

FIG. 5 illustrates an example block diagram of cellular communication circuitry, according to some aspects.

FIG. 6 illustrates an example block diagram of a network element, according to some aspects.

FIGS. 7A and 7B are diagrams illustrating an example beam management procedure, according to some aspects.

FIGS. 8A and 8B are diagrams illustrating an example of a beam management procedure for wireless communication and sensing, according to some aspects.

FIGS. 9A to 9D are diagrams illustrating example slot structures of a radio frame, according to some aspects.

FIG. 10 is a flowchart detailing a method of performing a collision control procedure, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study and evaluate resource allocation patterns for transmissions configured with communication and sensing resources simultaneously in 5G/New Radio (NR). To provide interleaving communication and sensing resources in a single transmission, disclosed herein are various solutions for arranging resources in various resource allocation patterns, including: 1) mapping of resources in a frequency band without frequency hopping; 2) mapping of resources in a frequency band with frequency hopping; and 3) mapping of resources in multiple frequency bands.

In accordance with one or more embodiments, a user equipment (UE) device or terminal communicating with other terminals may perform radio transmissions including communication information and sensing information simultaneously. In some embodiments, a UE device may be configured to jointly transmit the communication information and the sensing information. In some embodiments, these transmissions may be used by the UE device to exchange communication data and perform sampling for a sensor at a same time. The UE device may be configured to perform these transmissions as one or more JCAS transmissions. The one or more JCAS transmissions may be transmissions following protocols in which the UE device allocates communication resources and sensing resources simultaneously. In some embodiments, the UE device uses the JCAS transmission to allocate communication resources and sensing resources in one or multiple transmission frequency bands (e.g., bandwidth portions or parts, frequency ranges, subcarriers). The UE device may implement the JCAS transmissions in coordination with base stations and/or other terminals to prevent collisions of any transmitted data. The UE device may coordinate these JCAS transmissions with devices connected through multiple radio access technologies (RATs) (i.e., LTE-A, 5G NR, and the upcoming 6G).

In some embodiments, the UE device is configured to perform the JCAS transmissions without negatively impacting a user's experience. To achieve this, the UE device allocates sensing resources without taking data integrity away from communication resources allocated in a same transmission. Successful allocation of communication resources and sensing resources in the JCAS transmission may prevent data rate reductions, delay increases, or jitter. In some embodiments, the UE device uses the resource allocation in JCAS transmissions to reduce and/or eliminate gaps in data communications without compromising sensing accuracy or system responsiveness (i.e., sensing latency) and without adding to hardware components and costs. The UE device may coordinate resource allocation between communication operations and sensing operations to optimize communication performance or sensing performance, respectively. In some embodiments, the UE device may allocate, partially or as a whole, the same time-frequency resources (e.g., Resource Elements (REs)) for data communication and sensing (i.e., same resource elements may be used to communicate data and do sensing). In some embodiments, the UE device may allocate separate and coordinated time-frequency resources for data communication and sensing (i.e., multiplexing reduces in time and/or frequency).

In one or more embodiments, the UE device is a base station that coordinates JCAS transmissions with multiple cells including multiple UE devices and wireless terminals. The UE device may be configured to implement multiple resource allocation strategies for JCAS. The resource allocation strategies may include protocols to perform collision control and avoidance. The resource allocation strategies may include multiple options for mapping communication and sensing signals to time-frequency resource elements.

In some embodiments, an option for mapping communication and sensing signals may use a non-contiguous radiofrequency (RF) spectrum, in which different frequency ranges may be used simultaneously or in sequence to achieve both high detection rates and good accuracy of the resources allocated in the JCAS transmission. The mapping communication and sensing signals may include allocating resources for sensing purposes at a sensing instance that may, or may not, be contiguous in a frequency range.

For example, sensing resources may be allocated at separate locations along a frequency domain of the RF spectrum. The individual locations may have different over-the-air times. In this example, and as it will described in detail below, the allocated sensing resources may be interspersed with resources allocated for data communication. In some embodiments, the allocated sensing resources may be contained in the frequency domain by a bandwidth part (BWP) applicable at a sensing instant and a frequency range. Further, the allocated sensing resources may be contained by a predefined system bandwidth of a sensing frequency range or predefined capabilities of the UE device that may not be limited by any specific configured/applicable communication bandwidth.

The following is a glossary of terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner (e.g., by time multiplexing of execution threads).
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via a PC5 interface 108. The PC5 interface 108 may comprise one or more logical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

### Example User Equipment (UE)

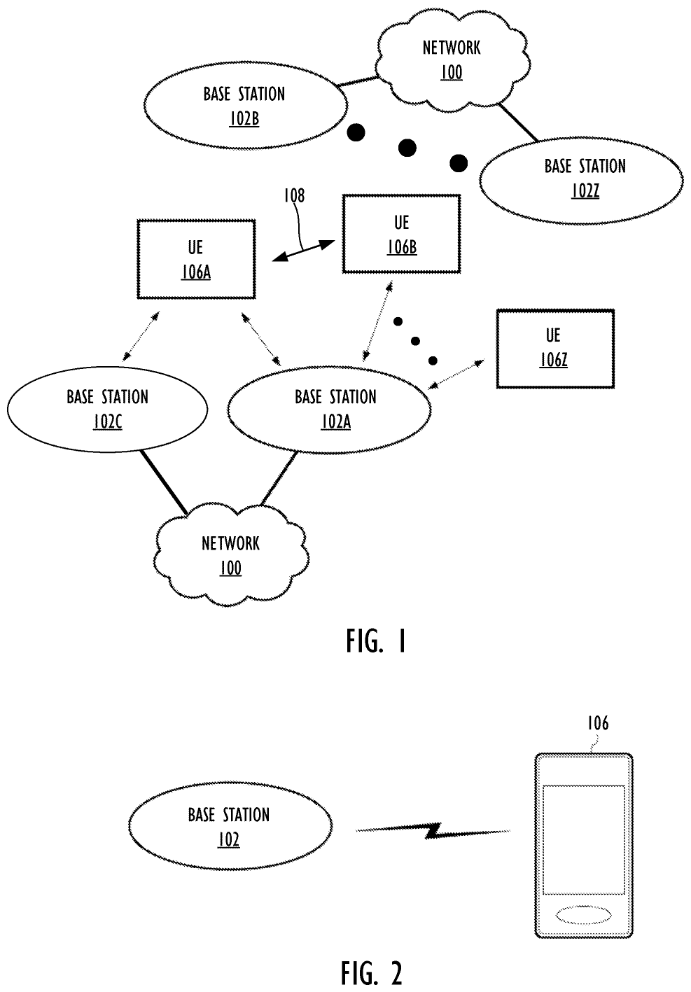

FIG. 2 illustrates user equipment 106 (e.g., one of the devices 106A through 106Z) in communication with a base station 102, according to some aspects. The UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

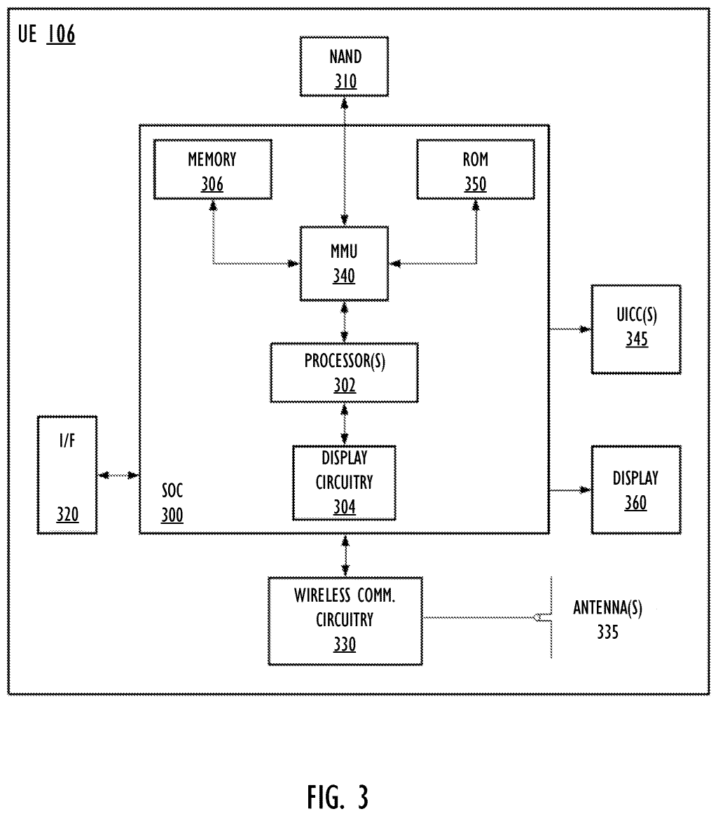

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

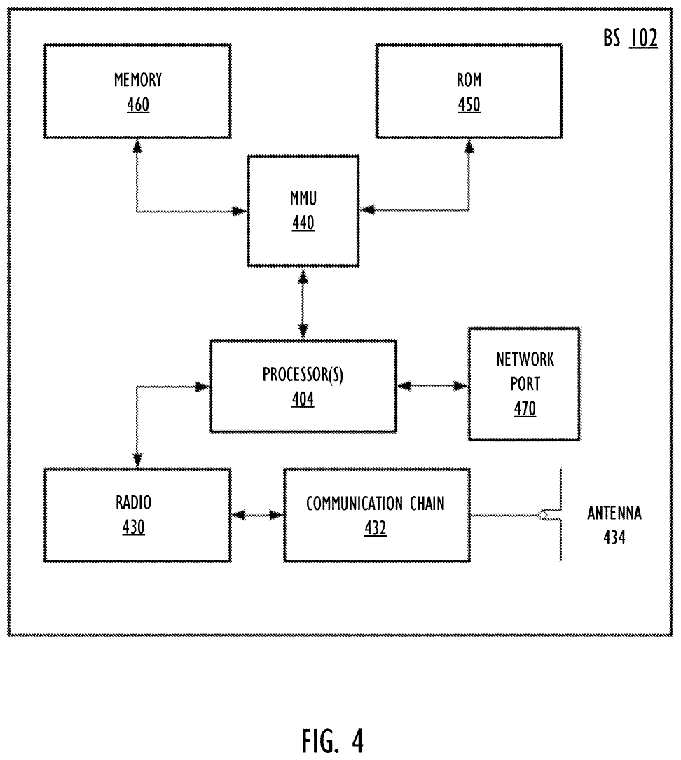

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Example Cellular Communication Circuitry

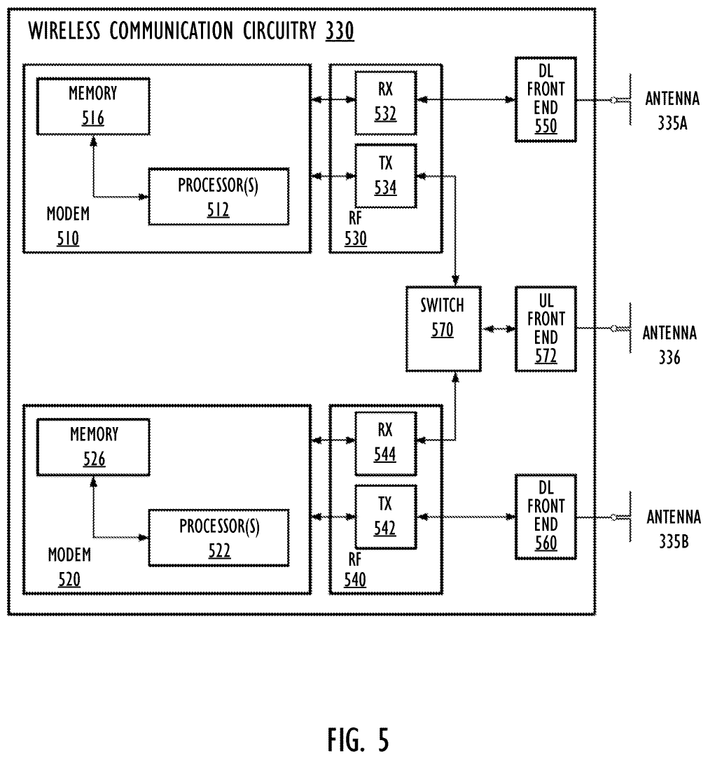

FIG. 5 illustrates an example simplified block diagram of cellular communication circuitry, according to some aspects. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 330 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a, 335b, and 336 as shown. In some aspects, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, and the like) configured to perform the functions of processors 512, 522.

In some aspects, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some aspects, the cellular communication circuitry 330 may also not include the switch 570, and the RF front end 530 or the RF front end 540 may be in communication, e.g., directly, with the UL front end 572.

### Example Network Element

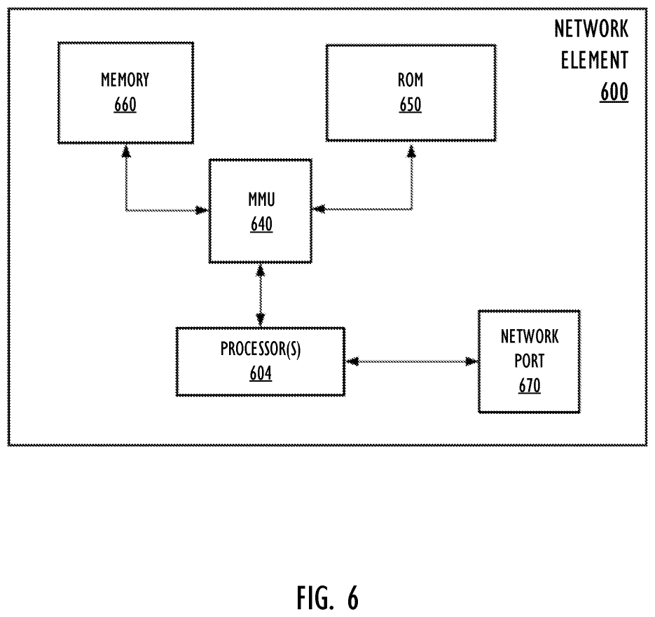

FIG. 6 illustrates an exemplary block diagram of a network element 600, according to some aspects. According to some aspects, the network element 600 may implement one or more logical functions/entities of a cellular core network, such as a mobility management entity (MME), serving gateway (S-GW), access and management function (AMF), session management function (SMF), network slice quota management (NSQM) function, and the like. It is noted that the network element 600 of FIG. 6 is a non-limiting example of a possible network element 600. As shown, the core network element 600 may include processor(s) 604 which may execute program instructions for the core network element 600. The processor(s) 604 may also be coupled to memory management unit (MMU) 640, which may be configured to receive addresses from the processor(s) 604 and translate those addresses to locations in memory (e.g., memory 660 and read only memory (ROM) 650) or to other circuits or devices.

The network element 600 may include at least one network port 670. The network port 670 may be configured to couple to one or more base stations and/or other cellular network entities and/or devices. The network element 600 may communicate with base stations (e.g., eNBs/gNBs) and/or other network entities/devices by means of any of various communication protocols and/or interfaces.

As described further subsequently herein, the network element 600 may include hardware and software components for implementing and/or supporting implementation of features described herein. The processor(s) 604 of the core network element 600 may be configured to implement or support implementation of part or all of the methods described herein, e.g., by executing program instructions stored on a memory medium (e.g., a nontransitory computer-readable memory medium). Alternatively, the processor 604 may be configured as a programmable hardware element, such as a Field Programmable Gate Array (FPGA), or as an Application Specific Integrated Circuit (ASIC), or a combination thereof.

### Example Beam Management

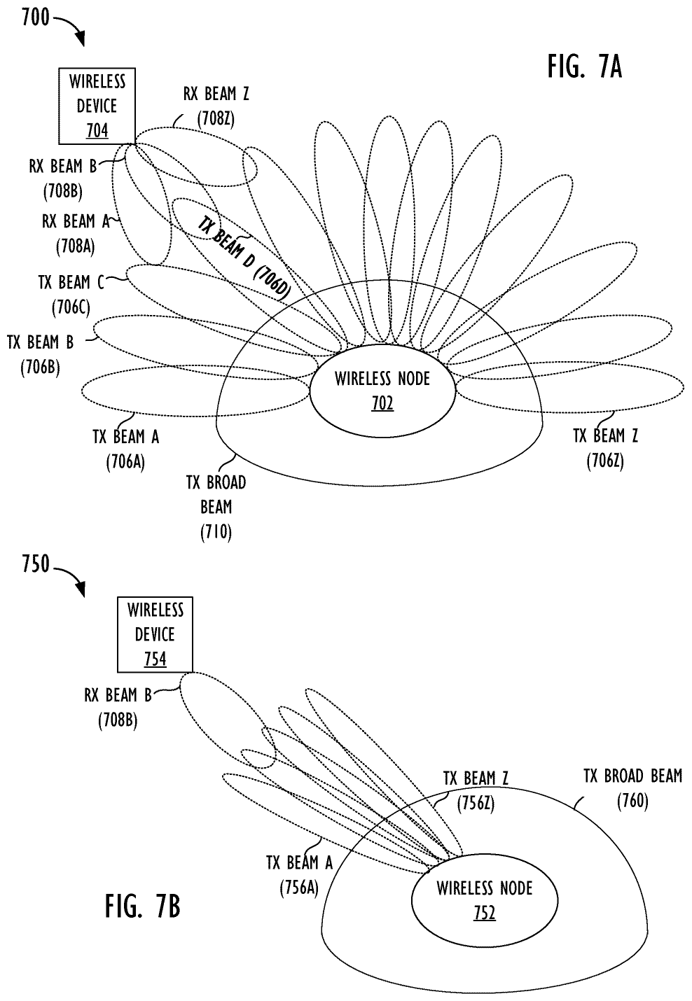

Beamforming may be used to help reduce interference and to help support a large number of wireless devices. Beamforming effectively allows a transmitter to transmit a dynamic, directional wireless signal toward a wireless device rather than transmitting a cell, or cell sector-wide wireless signal. These directional wireless signals may be referred to as beams. As the beams are directed toward a relatively small area as compared to a cell wide signal, a wireless node needs to know where a wireless device is located relative to the wireless node to allow the wireless node to direct beams toward the wireless device. FIGS. 7A and 7B are diagrams illustrating a beam management procedure, in accordance with aspects of the present disclosure. FIG. 7A is a conceptual diagram 700 illustrating an example beam sweeping procedure, in accordance with aspects of the present disclosure. In some wireless systems, a wireless node 702 may be configured with beamforming to transmit wireless signals as relatively narrow beams. To help a wireless device 704 to initially connect to the wireless node 702 when the wireless device 704 enters (e.g., moving into, turned on, exits airplane mode within, etc.) an area served by the wireless node 702, the wireless node 702 may sweep the area served using multiple wide transmit beams 706A . . . 706Z (collectively 706). Each beam of the multiple wide transmit beams 706 may be transmitted in predefined directions, with varying azimuths and elevations, and beam of the multiple wide transmit beams 706 may be transmitted periodically in a predefined order in the time domain. For example, the wireless node 702 may first transmit wide transmit beam A 706A at a certain time, then wide transmit beam B 706B 20 ms later, then wide transmit beam C 706C another 20 ms later, transmit beam D 706D another 20 ms later, and so on through wide transmit beam Z 706Z, and then repeating.

The transmit beams 706 and a transmit broad beam 710 may be used for JCAS transmissions. The transmit beams 706 may be transmitted at a narrower bandwidth and at longer distances than the transmit broad beam 710. The transmit beams 706 and the transmit broad beam 710 may be configured for performing the JCAS transmission at a predetermined frequency. The JCAS transmission may be transmitted at a bandwidth portion of the predetermined frequency. In some embodiments, the transmit beams 706 may be narrow beams that perform JCAS transmissions in a low frequency bandwidth portion. The transmit beams 706 may include JCAS transmissions that are configured to perform a long-distance sensing operation. In some embodiments, the transmit broad beam 710 may be broad beams that perform JCAS transmissions in a high frequency bandwidth portion. The transmit broad beam 710 may include JCAS transmissions that are configured to perform a short-distance sensing operation.

Ruled by the relation between frequency and wavelength in applications involving signal propagation, the higher the frequency of a bandwidth portion, the shorter the distance for sampling and vice versa. This relation is depicted as λ=c/f, where λ is a wavelength of a signal in meters (m), c is the speed of light in meters over second (m/s), and f is a frequency of the signal in hertz (Hz). In the aforementioned relation, the propagation wavelength is inversely proportional to the frequency of the propagation signal.

High frequencies and low frequencies may be relative to a RAT of operation of the wireless device 704 and the wireless node 702. In some RATs, high frequencies may include frequency ranges positioned at a top end of a frequency spectrum that a terminal may be configured to handle. Further, low frequencies may include frequency ranges positioned at a bottom end of the same frequency spectrum that the terminal may be configured to handle. For example, in 5G NR, high frequency bandwidth portions may be at a frequency range between 24.25 GHz to 52.6 GHz, inclusive. Further, low frequency bandwidth portions may be at a frequency range between 450 MHz to 6 GHZ, inclusive.

In accordance with aspects of the present disclosure, the wireless device 704 performs receive beamforming to conceptually generate corresponding receive beams. A receiving device may beamform by using multiple antennas and applying differing antenna amplification weights to the signals received by the multiple antennas to focus on signals received from a certain direction. The wireless device 704 may generate a set of receive beams and sweep an area for to receive Synchronization Signal (SS) bursts from the wireless node 702. In this example, the wireless device 704 may attempt to receive the SS bursts via receive beams 708A, 708B . . . 708Z (collectively 708). The wireless device 704 may also periodically sweep (e.g., point a receive beam at) an area around the wireless device 704 to receive the SS bursts. It may be understood that while three receive beams are shown in this example, other implementations may include any number of receive beams. Similarly, receive beams 708 may have varying shapes and sizes.

The wireless device 704 may measure a reference signal received power (RSRP) signal for pairs of wide transmit beams 706 and receive beams 708 to select a pair of a wide transmit beam and a receive beam associated with the best RSRP value. The selected wide transmit beam may be reported to the wireless node 702.

After a pair of the wide transmit beam and the receive beam have been selected, the wide transmit beams may be refined. FIG. 7B is a conceptual diagram 750 illustrating an example transmit beam refinement procedure, in accordance with aspects of the present disclosure. As shown, wireless node 752 may sweep a portion of the area, based on the selected wide transmit beam, using narrow transmit beams, here narrow transmit beams 756A . . . 756Z (collectively 756). The narrow transmit beams 756 may have a reduced angular area as compared to the wide transmit beams 706 or a transmit broad beam 760. One or more of the narrow transmit beams 756 may be received by the wireless device 754. The wireless device 754 receives the one or more of the narrow transmit beams 756 using the selected receive beam, here receive beam B 708B and measures a channel state information reference signal (CSI-RS) to estimate the channel for each of the received narrow transmit beams 756. The wireless device 754 may then select a narrow transmit beam of the received narrow transmit beams 756 associated with the best CSI and transmits an indication of the selected narrow transmit beam and CSI report to the wireless node 752. The CSI report includes the CSI information and may be sent to the wireless node to report the CSI information.

In some embodiments, the CSI-RS measurement provides a better channel quality estimation and channel capacity (e.g., spectral efficiency) estimation as compared to a power measurement provided by RSRP. In some cases, the CSI-RS measurements may be used to estimate a downlink channel and may indicate, in addition to RSRP information, channel capacity, frequency/time tracking, rank, demodulation, pre-coding information, and the like. In some cases, a beam associated with the best RSRP measurement may not be the same beam with the best CSI-RS measurement. As indicated above, the receive beam 708 may be selected based on RSRP measurements and it may be advantageous to evaluate multiple receive beams based on CSI-RS measurements.

In accordance with aspects of the present disclosure, the wireless device may be configured to evaluate different receive beams without initiating a beam refinement procedure with the wireless node. In cases where a wireless device is experiencing a relatively stable connection, (i.e., relatively stationary, stable environmental conditions, and the like) the wireless device may tune away from the currently selected receive beam to another receive beam to perform a CSI-RS measurement for the other receive beam. If the CSI measurements of the other receive beam indicate that the receive beam is better than the currently selected receive beam, the wireless device may select the other receive beam to use for transmissions from the wireless node.

After the transmit beam and the receive beam have been selected, the wireless node may configure the wireless device to perform CSI measurements to help manage the beams. In some cases, the wireless node may configure the wireless device for aperiodic CSI reporting. When configured for aperiodic CSI, the wireless device performs CSI reporting when indicated by the wireless node, for example, based on a higher-level DCI message. In some cases, the DCI message may be received via a physical downlink control channel (PDCCH).

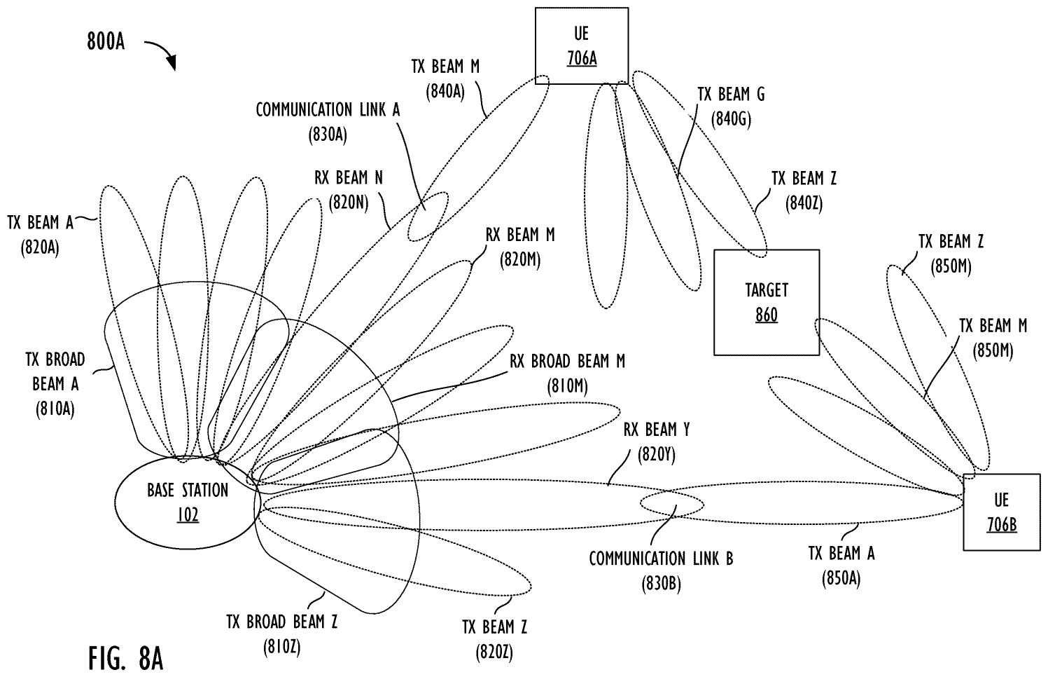

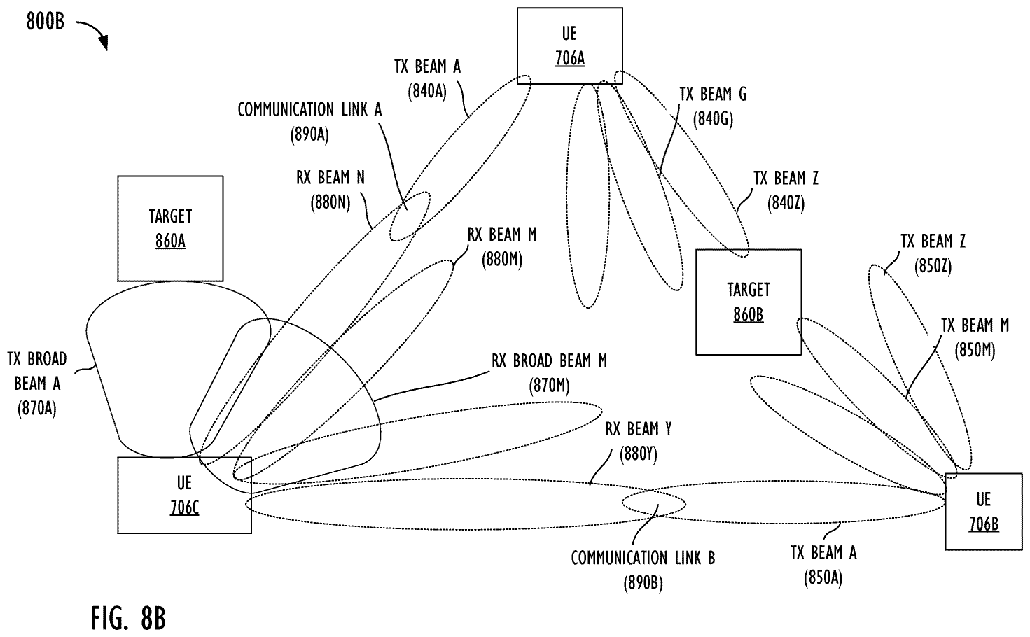

FIGS. 8A and 8B show diagrams 800A and 800B respectively illustrating examples of a beam management procedure for wireless communication and sensing, in accordance with one or more aspects. FIGS. 8A and 8B show wireless elements with multi-cell interference equipped with array antennas and capable of beamforming. The arrays in these wireless elements may be used both for sensing and high-rate low-latency communication to multiple users.

In the diagram 800A of FIG. 8A, the base station 102 coordinates sensing of a target 860 using JCAS transmissions in coordination with the UE 706A and the UE 706B. As described above, the JCAS transmissions may be coordinated to include communication resources and sensing resources at the same time. In this case, the base station 102 may include broad beams A 810A . . . 810Z (collectively 810) configured to identify targets at a short distance from the base station 102. Further, the base station 102 may include beams A 820A . . . 820Z (collectively 820) configured to identify targets at a long distance from the base station 102.

In some embodiments, the target 860 may comprise an object or a human or animal subject, whose presence is desired to be detected in a specific environment (e.g., a physical location such as a park or a coffee shop). The target 860 may be an object or a subject with a predetermined feedback signal or transmitter that may react to the JCAS transmission from the terminal. In one or more embodiments, the terminal may request permissions for transferring the JCAS transmission. The permissions may be acknowledged through higher layer signaling. In this case, the permissions may be required to confirm that resource allocation patterns are being coordinated among multiple JCAS transmissions. For example, to transmit the JCAS transmission in a licensed band, the terminal may need to confirm with a base station connected to the network that the licensed band has the space to perform the JCAS transmission at the requested resource allocation pattern. Similarly, to transmit the JCAS transmission in a licensed band, the terminal may need to confirm with the base station connected to the network that the power level of the JCAS transmission is at or below permitted safety/interference thresholds.

In some embodiments, the base station 102 may selectively use certain beams for receiving or transmitting JCAS transmissions. In the example shown in FIG. 8A, the base station 102 may use the transmit beam A 820A and transmit beam Z 820Z for transmitting JCAS transmissions. Further, the base station 102 may use the receive beam N 820N, the receive beam M 820M, and receive beam Y 820Y for receiving JCAS transmissions. The base station 102 may use broad beams in a similar manner. For example, the base station 102 may use the transmit broad beam A 810A and transmit broad beam Z 810Z for transmitting JCAS transmissions. Further, the base station 102 may use the receive broad beam M 810M for receiving JCAS transmissions.

The base station 102 may establish communication link A 830A and communication link B 830B with the UE 706A and the UE 706B, respectively. These communication links may be used by the base station 102 to provide the UE 706A and the UE 706B with instructions for sensing the target 860A. In each communication link, the UE 706A and the UE 706B may provide information to the base station 102 regarding sensing feedback. In this regard, the UE 706A uses transmit beam A 840A to provide a JCAS transmissions to the base station 102 while the UE 706A uses transmit beam G 840G and transmit beam Z 840Z to sense a location of the target 860A with respect to the base station 102. Further, the UE 706B uses transmit beam A 850A to provide a JCAS transmissions to the base station 102 while the UE 706B uses transmit beam M 850M and transmit beam Z 850Z to confirm the location of the target 860A with respect to the base station 102.

In the diagram 800B of FIG. 8B, the UE 706C coordinates sensing of a target 860A and a target 860B using JCAS transmissions in coordination with the UE 706A and the UE 706B. As described above, the JCAS transmissions may be coordinated to include communication resources and sensing resources at the same time. In this case, the UE 706C may include broad beam A 870A configured to identify targets at a short distance from the UE 706C. Further, the UE 706C may include beams N 880N . . . 880Y (collectively 880) configured to identify targets at a long distance from the UE 706C.

In the example shown in FIG. 8B, the UE 706C may selectively use certain beams for receiving or transmitting JCAS transmissions. In this example, the UE 706C may use the transmit broad beam A 870A for transmitting JCAS transmissions. Further, the UE 706C may use the receive beam N 880N, the receive beam M 880M, and receive beam Y 880Y for receiving JCAS transmissions. The UE 706C may use broad beams in a similar manner. For example, the UE 706C may use the transmit broad beam A 870A for transmitting JCAS transmissions. Further, the UE 706C may use the receive broad beam M 870M for receiving JCAS transmissions.

The UE 706C may establish communication link A 890A and communication link B 890B with the UE 706A and the UE 706B, respectively. These communication links may be used by the UE 706C to provide the UE 706A and the UE 706B with instructions for sensing the target 860B. In each communication link, the UE 706A and the UE 706B may provide information to the UE 706C regarding sensing feedback. In this regard, the UE 706A uses transmit beam A 840A to provide a JCAS transmissions to the UE 706C while the UE 706A uses transmit beam G 840G and transmit beam Z 840Z to sense a location of the target 860B with respect to the UE 706C. Further, the UE 706B uses transmit beam A 850A to provide a JCAS transmissions to the UE 706C while the UE 706B uses transmit beam M 850M and transmit beam Z 850Z to confirm the location of the target 860B with respect to the UE 706C.

In some embodiments, a terminal (e.g., the base station 102 or the UE 706C described in reference to FIGS. 8A and 8B) performing JCAS transmissions may be configured to jointly allocate communication resources and sensing resources. The terminal may allocate the resources for the JCAS transmission based on a terminal capability (i.e., parameters such as UE-Capability) preconfigured in the UE 706C and/or based on a terminal capability provided from a higher layer signaling obtained from a device connected directly to a network (i.e., a network gateway or a base station if the terminal is a UE device). In some embodiments, the terminal confirms a resource allocation pattern with another terminal expected to receive the JCAS transmission before the transmission is performed. The terminal capability may indicate resource allocation support information for the terminal.

In one or more embodiments, the terminal performs the JCAS transmission to perform a collision control procedure in a communication network by assigning allocation of communication resources and sensing resources to other terminals being used for performing one or more communication operations and/or sensing operations.

In some embodiments, the terminal may use the JCAS transmissions to identify or request movement information from a target device. The movement information may include an ordered series of points. This information may be obtained by the target device using one or more motion sensors located in the target device. In the series of points, the target device may indicate any sensor modes supported by the target device. The series of points may be represented by a bit string, with a one-value at the bit position means the particular sensor mode is supported; a zero-value means not supported.

In one or more embodiments, two UE devices communicating with one another may exchange JCAS transmissions using a Sidelink (SL) communication link. The Sidelink communication link is a special kind of communication mechanism between UE devices without going through a base station. In some embodiments, the Sidelink and related messages are defined in section 6.3.8 TS 36.331 of the 3GPP standard.

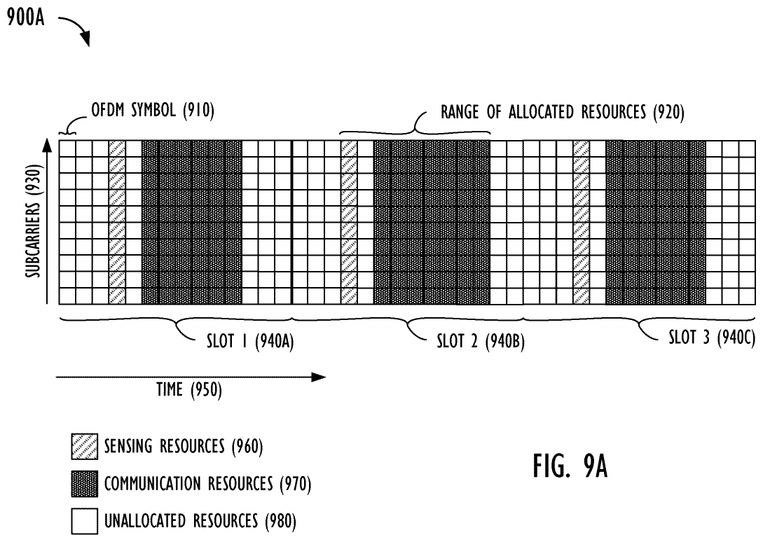

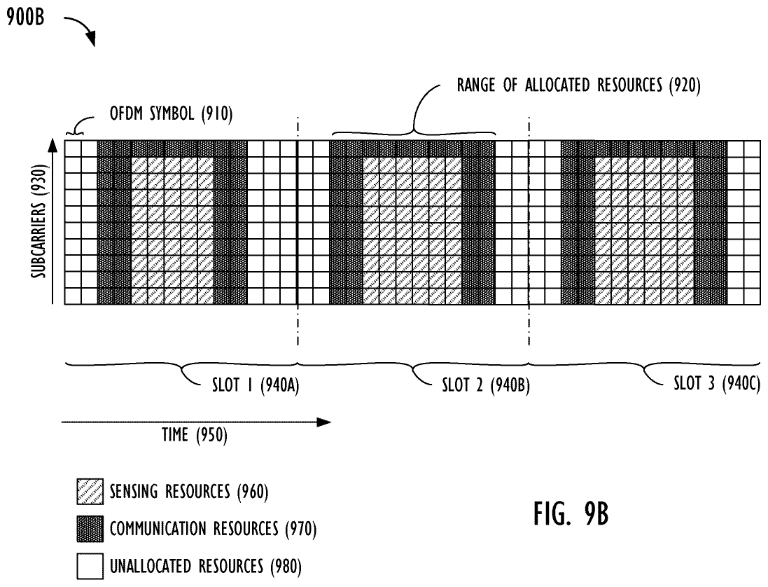

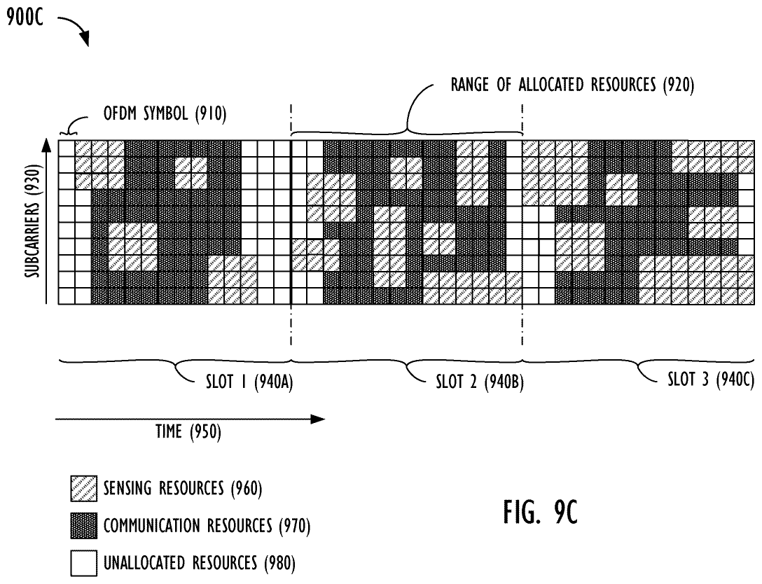

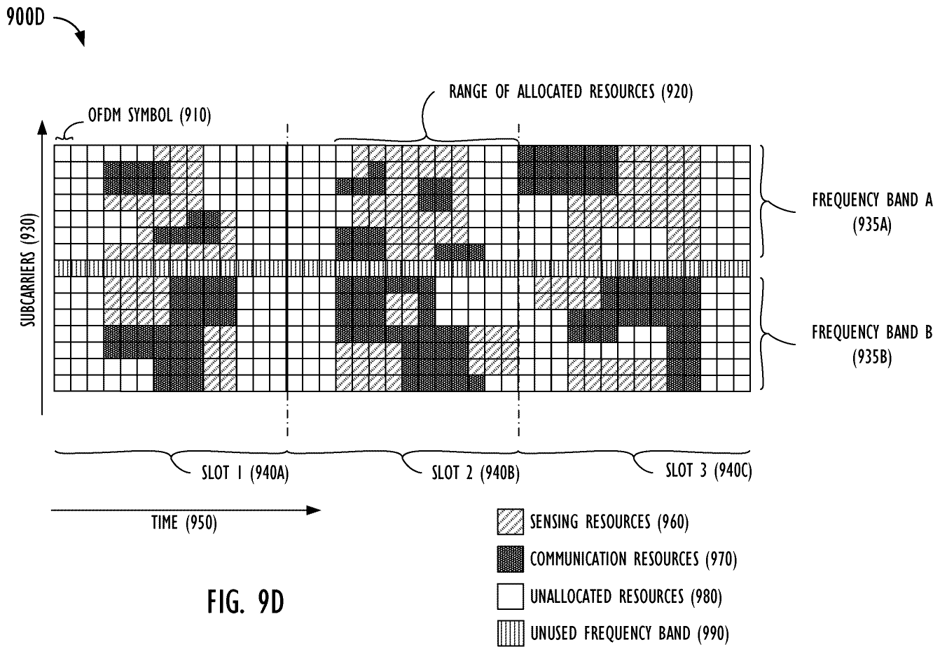

FIGS. 9A-9D illustrate diagrams 900A-900D illustrating slot structures of a radio frame in a JCAS transmission (e.g., a joint transmission) from a terminal, in accordance with aspects of the present disclosure. In the examples of FIGS. 9A-9D, slots 940A, 940B, and 940C are shown as a resource gird including a vertical axis 930 corresponding to different frequencies/subcarriers and a horizontal axis 950 corresponding to a time domain. Each column in the resource grid represents an OFDM symbol 910. In these examples, periodic JCAS transmissions 900A-900D may be scheduled for each slot in accordance with a predefined pattern. Each JCAS transmission, may include multiple sensing resources 960, multiple communication resources 970, and multiple unallocated resources 980. The sensing resources 960 and the communication resources 970 collectively cover a range of allocated resources 920. Further, each pattern may be configured in accordance with a terminal capability preconfigured in the terminal or a terminal capability provided by higher layer signaling.

In the examples shown in FIGS. 9A-9D, multiple resource allocation patterns are shown for any given JCAS transmission. In FIG. 9A, pattern 900A includes sensing resources 960 and communication resources 970 allocated separated from one another in the time domain. In this pattern, unallocated resources 980 implement a gap of one or more OFDM symbols in the range of allocated resources 920, which may require the receiving terminal (i.e., UE device or base station) to account for a first sequence of sensing and a second sequence of communication.

In FIG. 9B, pattern 900B includes sensing resources 960 and communication resources 970 partially overlapping in the time domain. In this pattern, allocated resources overlap in at least one part (e.g., a same OFDM symbol assigned for both communication and sensing) of the range of allocated resources 920. In JCAS transmissions following this pattern, communication operations may completely ignore sensing operations. As a result, communication operations may have resources allocated to most of the OFDM symbols. Once the communication resources are allocated, sensing operations may have resources allocated to override/replace certain communication resources allocated to certain OFDM symbols.

In FIG. 9C, pattern 900C includes sensing resources 960 “hopping” around communication resources 970 in a same frequency band, e.g., with sensing resources 960 changing frequency ranges for each successive time occasion of communication sensing. In this pattern, allocated resources overlap in at least one part of the range of allocated resources 920. In JCAS transmissions following this pattern, communication resources for communication operations may be allocated before the sensing resources. As a result, when sensing resources are allocated, sensing resources may override/replace communication resources while being allocated.

In FIG. 9D, pattern 900D includes sensing resources 960 hopping around communication resources 970 in at least two separate frequency bands. In this pattern, allocated resources may follow a similar procedure to the one followed in pattern 900C. The difference in pattern 900D is an unused frequency band 990 that serves as a separation between frequency band A 935A and frequency band B 935B. As mentioned above, allocated sensing resources do not have to be contiguous in the frequency domain. As a result, sensing resources may be allocated either concurrently or in sequence using different frequency bands. In one aspect, sensing resources may use low frequencies and high frequencies in the manner discussed in reference to FIGS. 7A and 7B.

### Exemplary Method for Performing a Collision Control Procedure

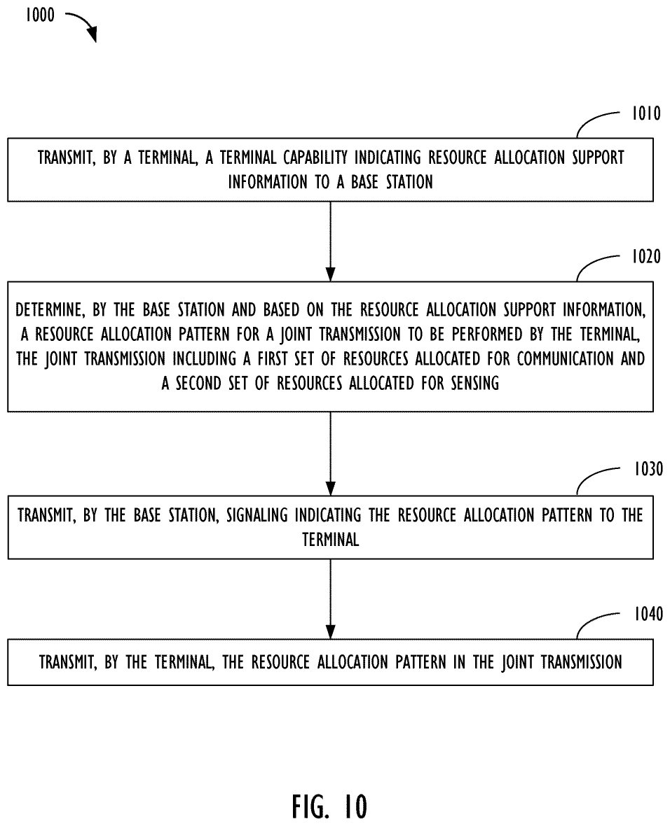

Turning to FIG. 10, a flowchart 1000 is shown, detailing a method of performing a collision control procedure in a communication network. In this example, the method is executed by the terminal and the base station exchanging information through a communication link (e.g., similar to communication links 830A, 830B, 890A, or 890B described in reference to FIGS. 8A and 8B) in preparation for a JCAS transmission. At 1010, the flowchart begins with the terminal transmitting a terminal capability indicating resource allocation support information to a base station. The terminal capability may be a parameter preconfigured in the terminal via higher layer signaling. The terminal capability may indicate resource allocation support information in the form of an acceptable resource allocation pattern. The acceptable resource allocation pattern may be any resource allocation pattern that the terminal is pre-configured to handle. Acceptable resource allocation patterns may be one or more of the resource allocation patterns described in reference to FIGS. 9A-9D.

At 1020, the flowchart continues with the base station determining, based on the resource allocation support information, a resource allocation pattern for a JCAS transmission to be performed by the terminal. The JCAS transmission may include a first set of resources allocated for communication and a second set of resources allocated for sensing. The first set of resources allocated for communication includes a plurality of communication instances and the second set of resources allocated for sensing includes a plurality of sensing instances. The resources allocated for sensing and the resources allocated for communication may be the sensing resources 960 and the communication resources 970, respectively. These resources are described in reference to FIGS. 9A-9D.

In some embodiments, at least one part of the second set of resources allocated for sensing may overlap the first set of resources allocated for communication in the resource allocation pattern. In other embodiments, an entirety of the second set of resources allocated for sensing may overlap the first set of resources allocated for communication in the resource allocation pattern. In yet other embodiments, none of the second set of resources allocated for sensing overlap the first set of resources allocated for communication in the resource allocation pattern.

At 1030, the flowchart continues with the base station transmitting signaling indicating the resource allocation pattern to the terminal. As described in reference to the examples in FIGS. 9A-9D, the resource allocation pattern in some embodiments may indicate that the second set of resources allocated for sensing are fixed in a frequency domain during each sensing instant in the resource allocation pattern. In other embodiments, the second set of resources allocated for sensing may be fixed in a frequency domain during each sensing instant in the resource allocation pattern. In yet other embodiments, the second set of resources allocated for sensing are allocated in two or more frequency bands in the resource allocation pattern.

The flowchart ends at 1040 with the terminal implementing the resource allocation pattern in the JCAS transmission. At a point when the terminal implements the resource allocation pattern, the terminal jointly implements communication and sensing by generating a JCAS transmission.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or, any subset of any of the method aspects described herein, or, any combination of such subsets).

In some aspects, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A first terminal, comprising:
a processor configured to determine a resource allocation pattern to be used in a joint transmission to a second terminal, the resource allocation pattern being determined based on a terminal capability of the first terminal; and
a transmitter that transmits, to the second terminal, a first signal indicating the resource allocation pattern to be used in the joint transmission, the resource allocation pattern including a first set of resources allocated for communication and a second set of resources allocated for sensing.

2. The first terminal of claim 1, wherein:
the second terminal is a base station,
the transmitter further transmits, to the base station and before the resource allocation pattern is determined, the terminal capability indicating resource allocation support information, and
the receiver further receives, from the base station, signaling suggesting the resource allocation pattern to be used in the joint transmission, the resource allocation pattern being determined by the base station based on the terminal capability of the first terminal.

3. The first terminal of claim 2, wherein the joint transmission is a joint communication and sensing (JCAS) transmission configured to perform a collision control procedure in a communication network including the terminal and the base station.

4. The first terminal of claim 2, wherein:
the transmitter further transmits a sensing request to the base station, in which the terminal requests permission to perform a sensing procedure using the joint transmission, and
the receiver further receives a request approval from the base station, in which the base station indicates a transmission time for transmitting the joint transmission.

5. The first terminal of claim 2, wherein:
the processor is further configured to determine a bandwidth portion for transmitting the joint transmission, and
the bandwidth portion is a high frequency bandwidth portion when the second set of resources allocated for sensing are configured to perform a short-distance sensing operation.

6. The first terminal of claim 2, wherein:
the processor is further configured to determine a bandwidth portion for transmitting the joint transmission, and
the bandwidth portion is a low frequency bandwidth portion when the second set of resources allocated for sensing are configured to perform a long-distance sensing operation.

7. The first terminal of claim 2, wherein the processor is further configured to determine a bandwidth portion for transmitting the joint transmission, the bandwidth portion including a subcarrier configured to perform a presence detection operation.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A computer readable-medium including instructions that, when executed by at least one computer processor, cause the at least one computer processor to:
determine a resource allocation pattern to be used in a joint transmission to a second terminal, the resource allocation pattern being determined based on a terminal capability of the first terminal; and
configure a transmitter to transmit, to the second terminal, a first signal indicating the resource allocation pattern to be used in the joint transmission, the resource allocation pattern including a first set of resources allocated for communication and a second set of resources allocated for sensing.

27. (canceled)

28. (canceled)

29. (canceled)

30. (canceled)

31. (canceled)

32. (canceled)

33. The computer readable-medium of claim 26, wherein at least one part of the second set of resources allocated for sensing overlap the first set of resources allocated for communication in the resource allocation pattern.

34. The computer readable-medium of claim 26, wherein an entirety of the second set of resources allocated for sensing overlap the first set of resources allocated for communication in the resource allocation pattern.

35. The computer readable-medium of claim 26, wherein none of the second set of resources allocated for sensing overlap the first set of resources allocated for communication in the resource allocation pattern.

36. The computer readable-medium of claim 26, wherein:
the first set of resources allocated for communication includes a plurality of communication instances, and
the second set of resources allocated for sensing includes a plurality of sensing instances.

37. The computer readable-medium of claim 26, wherein the second set of resources allocated for sensing are fixed in a frequency domain during each sensing instance in the resource allocation pattern.

38. The computer readable-medium of claim 26, wherein the second set of resources allocated for sensing hop in a frequency domain during each sensing instance in the resource allocation pattern.

39. The computer readable-medium of claim 26, wherein the second set of resources allocated for sensing are allocated in two or more frequency bands in the resource allocation pattern.

40. (canceled)

41. A method for performing a collision control procedure in a communication network, comprising:
transmitting, by a terminal, a terminal capability indicating resource allocation support information to a base station;
receiving, at the terminal, a resource allocation pattern for a joint transmission to be performed by the terminal, wherein the resource allocation pattern is determined by the base station and based on the resource allocation support information, and wherein the resource allocation pattern includes a first set of resources allocated for communication and a second set of resources allocated for sensing; and
implementing, by the terminal, the resource allocation pattern in the joint transmission.

42. (canceled)

43. (canceled)

44. (canceled)

45. (canceled)

46. The method of claim 41, wherein none of the second set of resources allocated for sensing overlap the first set of resources allocated for communication in the resource allocation pattern.

47. The method of claim 41, wherein the second set of resources allocated for sensing are fixed in a frequency domain during each sensing instant in the resource allocation pattern.

48. The method of claim 41, wherein the second set of resources allocated for sensing hop in a frequency domain during each sensing instant in the resource allocation pattern.

49. The method of claim 41, wherein the second set of resources allocated for sensing are allocated in two or more frequency bands in the resource allocation pattern.
